(19) United States
(12) Patent Application Publication
(10) Pub. No.: US 2025/0065938 A1
(43) Pub. Date: Feb. 27, 2025

(54) HEAVY DUTY FURNITURE MOVER

(71) Applicant: Rongfang Xu, Yulin (CN)

(72) Inventor: Rongfang Xu, Yulin (CN)

(21) Appl. No.: 18/236,491

(22) Filed: Aug. 22, 2023

(51) Int. Cl. B62B 5/00

(52) U.S. Cl. CPC B62B 5/0093; B62B 2202/30

(57) ABSTRACT

A heavy duty furniture mover comprising: a clamshell, wherein the clamshell comprises an upper housing and a lower housing, and a moving device and an elastic device are provided therebetween; the clamshell is equipped with a connection plate, which is detachably attached to the upper housing and connected with the lower housing, having at least one elastomer on one end face and a moving device on the other end face; wherein the moving device comprises at least one universal wheel and at least one fixed cover provided on the connection plate, the lower housing is provided with at least one exposed hole, and the fixed cover cooperates with the lower housing in a rollable fixed connection of the universal wheel. Whereby, some small balls are provided between the fixed cover and the universal wheel.

### TECHNICAL FIELD

The present invention relates to the technical field of mobile devices, and in particular relates to a heavy duty furniture mover.

### BACKGROUND

As people's living standards continue to improve, their furniture needs are becoming more diverse. However, one of the resulting problems is that moving and handling heavy furniture becomes very difficult and time-consuming when the living space needs to be rearranged or the furniture needs to be repaired. To solve this problem, heavy duty furniture movers have been created.

However, the heavy duty furniture mover on the market is difficult to maintain stability when the ground is uneven, the wheels cannot be switched in any direction, the wheels fall off arbitrarily when the load is unbalanced, and the universal wheels are easily jammed when handling heavy loads. For example, the moving device disclosed in U.S. Pat. No. 8,690,169 is susceptible to bumps when the road surface is uneven, the wheels cannot be switched to move in any direction, the wheels are susceptible to falling off when the goods are unbalanced, and the universal wheels are susceptible to jamming when moving the heavy duty furniture mover. Similarly, the mobile device disclosed in U.S. Pat. No. 11,351,817 also suffers from the problems that it is difficult to maintain stability, the wheels cannot be switched to move in any direction and are easy to fall off, and the universal joints are easy to jam.

Based on the above problems, it is necessary to propose a new type of heavy duty furniture mover, the moving device has a stable lifting function, the wheels can be found towards the personnel to move and is not easy to fall off, the universal wheel will not heat up jammed, can facilitate the user to carry heavy duty furniture mover more effectively and conveniently in life.

### SUMMARY

The present invention provides a heavy duty furniture mover which consists of a clamshell containing an upper housing and a lower housing, a moving device, an elastic device, and a connection plate provided within the clamshell. The connection plate is detachably attached to the upper housing and has a fixed connection with the lower housing. One end face of the connection plate is equipped with at least one elastomer, and a connection plate moving device is provided on the other end face. The moving device is made up of at least one universal wheel and at least one fixed cover provided on the connection plate. The lower housing has at least one exposed hole, and the fixed cover cooperates with the lower housing to securely connect the universal wheel in a rollable manner, with small balls provided between the fixed cover and the universal wheel. Wherein, the upper housing is provided with at least one anti-slip mat.

The present invention provides a method for moving a heavy load, comprising providing a plurality of heavy duty furniture movers, the heavy duty furniture movers comprising a support assembly, an elastomer provided under the support assembly, a moving device provided under the elastomer, the moving device comprising at least one universal wheel having a plurality of ball bearings: placing the plurality of heavy duty furniture movers at the lower end of the heavy load and forming a support for the heavy load so as to lift the heavy load from the ground; pushing the heavy load so that the heavy load is moved using the heavy duty furniture movers to finally reach a predetermined location; and moving the heavy load away from the heavy duty furniture mover.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 shows a schematic view of the heavy duty furniture mover;

FIG. 2 shows another schematic view of the heavy duty furniture mover;

FIG. 3 shows a sectional view of the heavy duty furniture mover;

FIG. 4 shows an enlarged schematic view at M in FIG. 3;

FIG. 5 shows an exploded schematic view of the heavy duty furniture mover:

FIG. 6 shows another schematic view of the upper housing, the lower housing, the nail sleeve and the connection plate;

FIG. 7 shows another schematic view of the upper housing.

In the drawings:

1000, clamshell; 1100, upper housing; 1101, nail hole; 1102, hook hole; 1103, fixing strip; 1104 clip slot 1105, nail cover slot; 1106, through hole C; 1200, lower housing; 1201, exposed hole; 1202, inner wall; 1203, ring tab; 1204, threaded hole B; 1205, threaded hole F; 1206, screwdriver boss; 1301, universal wheel; 1302, fixed cover; 1303, small balls; 1304, snap ring; 1401, elastomer; 1500, connection plate; 1501, receiver; 1502, cap slot; 1503, snap clip; 1504, threaded hole A; 1505, nail slot; 1506, snap ring slot; 1507, base slot; 1508, through hole E; 1509, boss groove; 1600, anti-slip mat; 1601, nail; 1700, nail sleeve; 1701, through hole D; 1702, nail sleeve head; 1703, nail sleeve base; 1704, nail sleeve inner groove.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on.” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a.” “an.” and “the” are intended to include the plural forms as well, unless the context clearly indicates other.

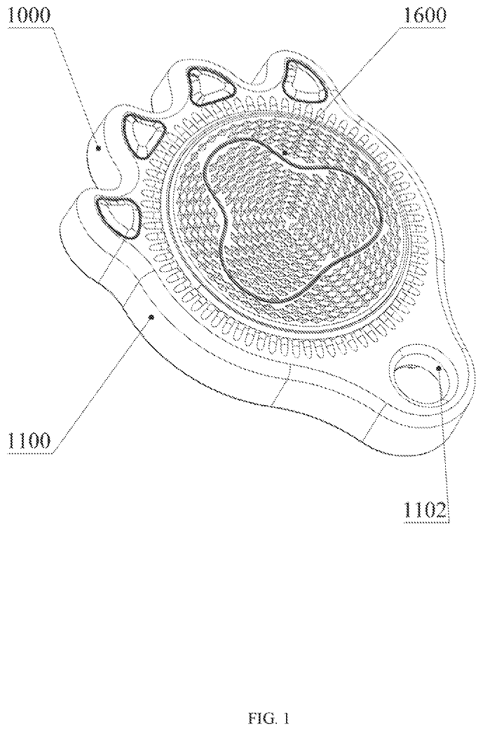

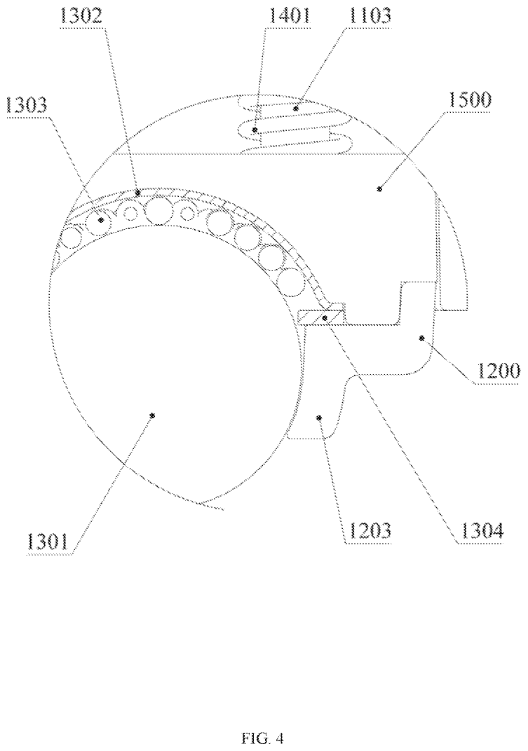

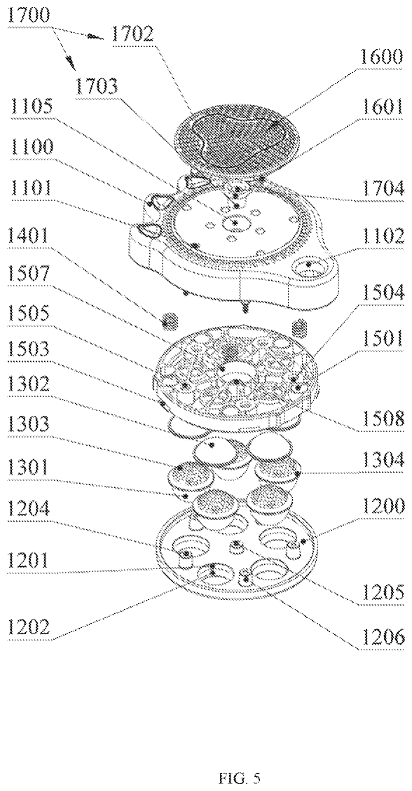

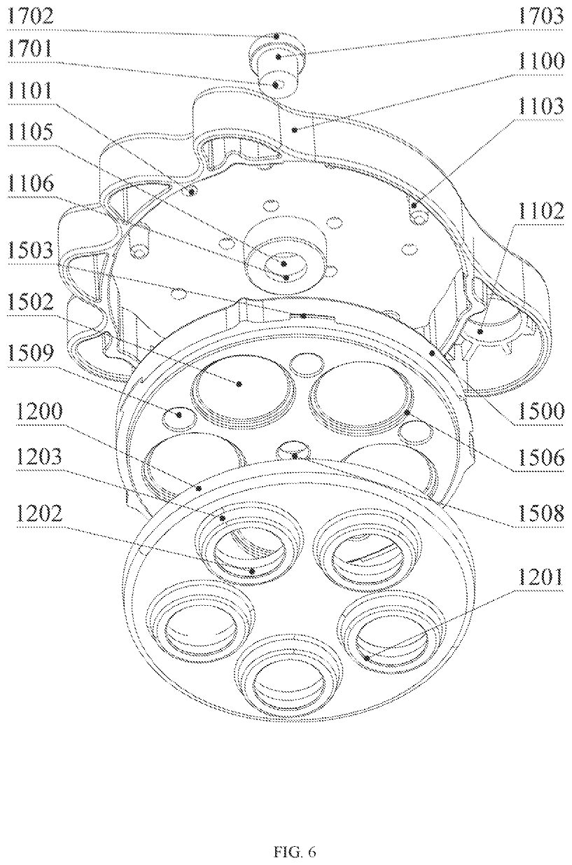

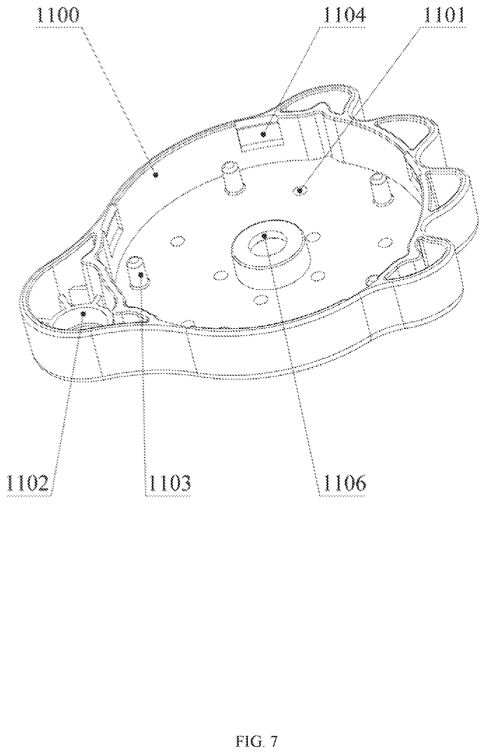

As shown in FIGS. 1 to 7, the present invention provides a heavy load moving apparatus comprising a clamshell 1000, the clamshell 1000 including an upper housing 1100 and a lower housing 1200, a moving device and an elastic device provided between the upper housing 1100 and the lower housing 1200, a connection plate 1500 provided within the clamshell 1000, wherein the connection plate 1500 is detachably attached to the upper housing 1100 and forms a fixed connection with the lower housing 1200, wherein one end face of the connection plate 1500 is provided with at least one elastomer 1401 and another end face of the connection plate 1500 is provided with the moving device; said moving device comprising at least one universal wheel 1301 and at least one fixed cover 1302 provided on said connection plate 1500, wherein said lower housing 1200 is provided with at least one exposed hole 1201 and said fixed cover 1302 co-oper with lower housing 1200 to fixedly connect said universal wheel 1301, wherein small balls 1303 are provided between fixed cover 1302 and said universal wheel 1301.

As shown in FIGS. 1 to 4, in this embodiment, upper housing 1100 is provided with anti-slip mat 1600, upper housing 1100 is provided with at least one nail hole 1101, anti-slip mat 1600 protrudes with at least one nail 1601, and upper housing 1100 and anti-slip mat 1600 are fixedly connected by pinning. The anti-slip mat 1600 increases the friction between the product and the object to be transported, acts as a fixing force, and makes the product not easily separable from the goods in the process of use. In other embodiments (not shown in the figures), the connection of the upper housing 1100 and the anti-slip mat 1600 is not limited to a nail connection, but may also be a screw connection and other arbitrary connection methods as desired. In other embodiments (not shown in the figures), the material of the anti-slip mat 1600 is not limited to rubber, but may also be PVC, silicone, and other arbitrary materials as desired. In other embodiments (not shown in the figures), the anti-slip mat 1600 is not limited to one, but may also be two, three, and any other number of anti-slip mats 1600 as desired.

As shown in FIGS. 1 to 7, in this embodiment, upper housing 1100 is set in the shape of an animal paw, set as a paw of a cat, and is set with an animal paw pattern, which enhances the ornamental properties and can be used as a decorative object when not in use. In other embodiments (not shown in the drawings), upper housing 1100 is not limited to the animal paw shape, but can also be a boat shape, a car shape, and any other geometric shape as desired. In this embodiment, upper housing 1100 is also provided with hanging hook holes hook hole 1102, hook hole 1102 is provided with chamfered corners, which can be convenient for the user to have more storage options when not in use, and is more convenient and faster when hanging. In other embodiments (not shown in the figures), the upper housing 1100 is also provided with a hook and loop fastener, which can facilitate storage when not in use.

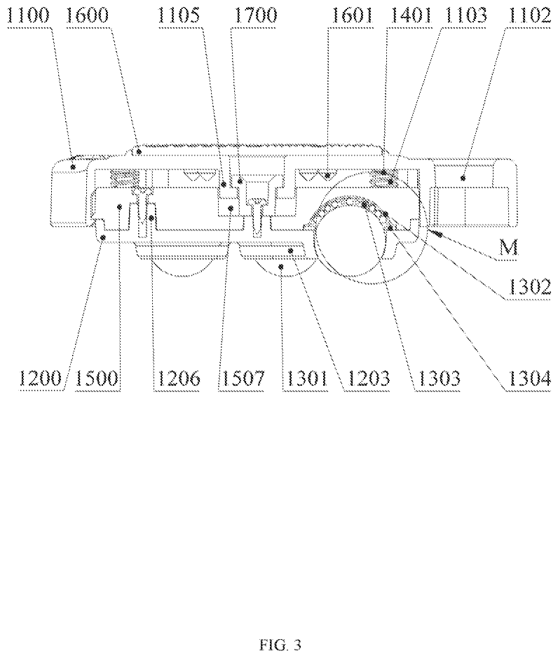

As shown in FIGS. 3 to 6, in this embodiment, elastic device includes upper housing 1100 provided with at least one fixing strip 1103, which fixing strip 1103 can fix elastomerelastomer 1401, and connection plate 1500 provided with at least one receiver 1501, which protects elastomerelastomer 1401 and fixing strip 1103. The elastic device realizes the lifting and stabilizing function of the product, which enables the user to carry the product when the floor is uneven and has a better performance. In other embodiments, the retaining strip 1103 may be provided on the attachment disk 1500 and the receiving seat 1501 may be provided on the upper housing. In this embodiment, the elastomer 1401 is provided as a compression spring. In other embodiments (not shown in the figures), the elastomer 1401 is not limited to a compression spring, but can also be a steel plate spring, a gas spring, and any other elastomer 1401 that meets the requirements.

Among them, the compression springs include, cylindrical compression springs: is the most common type of compression spring, it is coiled by the round cross-section of the wire, with linear or nearly linear load-deformation characteristics, cylindrical compression springs, the advantages of simple structure, easy to manufacture, widely used, cylindrical compression springs, the disadvantage is that it is easy to produce the phenomenon of self-oscillation, the end of cylindrical compression springs, the end of the structure of the flat end, flat end smoothing, slant end non-linear compression spring: It is a kind of compression spring with non-linear load-deformation characteristics, it can be changed by changing the wire diameter, pitch, winding ratio and other parameters to achieve different stiffness changes, the advantage of non-linear compression springs is that they can meet the special operating requirements, such as constant load, progressive load, two-stage load, etc., The disadvantage of non-linear compression spring is the structure is complex, difficult to manufacture, high cost: combination compression spring: this is a simple, easy to manufacture, widely used, the disadvantage of cylindrical compression spring is prone to self-vibration phenomenon. The disadvantage of non-linear compression spring is that it is complicated in structure, difficult to manufacture and costly. Combination compression springs: These are compression springs made of several different or identical compression springs connected in series or in parallel, which can realize a variety of complex load-deformation characteristics. The advantage of combination compression springs is that they can expand the working range, improve reliability and reduce cost.

As shown in FIGS. 3 to 6, in this embodiment, at least one cap slot 1502 embedded in fixed cover 1302 is provided on connection plate 1500, with snap ring 1304 attached to fixed cover 1302, and snap ring slot 1506 embedded in snap ring 1304 is provided outside of cap slot 1502, with snap ring 1304 further restricting the movement of universal wheel 1301 and restricting small balls 1303 between the fixed cover 1302 and the universal wheel 1301. In this embodiment, the universal wheel 1301 is provided in a spherical shape. In other embodiments (not shown in the figures), universal wheel 1301 is not limited to a spherical shape, but may also be hub-shaped and other arbitrary shapes as desired. In this embodiment, the universal wheel 1301 is provided as a metal ball. In other embodiments (not shown in the drawings), the material of universal wheel 1301 is not limited to metal, but may be wood, plastic, and other arbitrary materials as desired. small balls 1303 as a smooth part of universal wheel 1301, so that when the product is transporting a heavy object, universal wheel 1301 does not heat up and jam: so that the user can get a smoother and more comfortable feeling of use when transporting a heavy object, and avoid the adverse effects of falling and other adverse effects caused by jamming. In this embodiment, the small balls 1303 are provided as a small glass bead. In other embodiments (not shown in the drawings), small balls 1303 is not limited to a small glass bead, but can also be a small steel bead, a small iron bead, and any other material small balls 1303 that meets the requirements. In other embodiments, the universal wheel may be provided as a wheel that can be displaced in any direction.

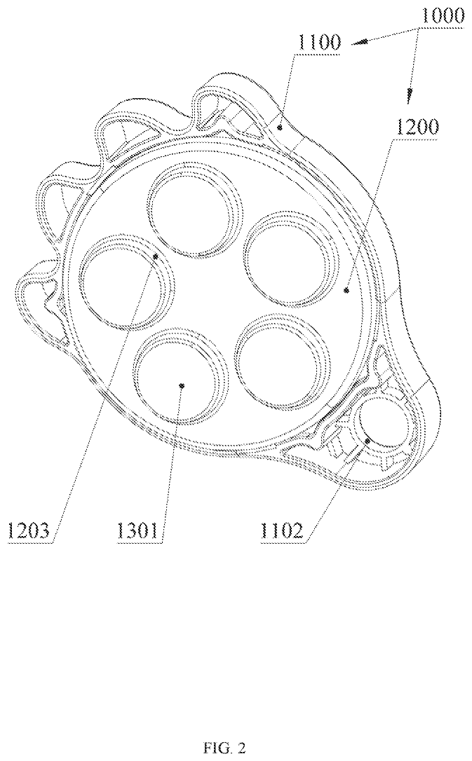

As shown in FIGS. 2 to 6, in this embodiment, lower housing 1200 is provided with exposed hole 1201, and exposed hole 1201 exposes universal wheel 1301 while fixing universal wheel 1301 so that universal wheel 1301 can be contacted with the outside world. Inner wall 1202 of exposed hole 1201 provided by lower housing 1200 is provided with a curved surface corresponding to universal wheel 1301. This structure enables universal wheel 1301 to be fixed while having better rotational characteristics. In other embodiments, inner wall 1202 is not limited to a curved surface, but can also be formed as a structure of a curved surface with annular projections and any other shaped structure that meets the requirements. In this embodiment, the lower housing 1200 is provided with at least one extension ring tab 1203 of the exposed hole 1201, wherein the ring tab 1203 is provided with rounded corners. The extension of the exposed hole 1201 allows for better stability of the universal wheel 1301. In other embodiments (not shown in the figures), the connection of the connection disk 1500 to the upper housing 1100 is not limited to a snap connection, but may also be a moveable screw connection, a tension spring connection, and any other connection as desired.

In some embodiments (not shown in the drawings), the connection methods are threaded connection, welding, riveting, bonding, and the like. Threaded connection is the most commonly used connection method, which has the greatest advantage of being easy to assemble and disassemble, and the disadvantage of having to be well relaxed. The advantage of welding is that the connection is secure, the disadvantage is that it is not removable, welding defects are easy to exist. The advantage of riveting is used in case of threaded connection and welding is not convenient, the disadvantage is not repeatable disassembly. Adhesive bonding is used for bonding light density parts, bonding is convenient, the disadvantage is that the adhesive bonding weather resistance is poor, easy to aging. Other connection methods include: bayonet connection, pin connection, snap ring connection, elastic ring connection, locking connection, mortise and tenon connection and so on.

As shown in FIGS. 3 to 6, in this embodiment, the connection plate 1500 has a snap clip 1503 protruding from the side wall, the upper housing 1100 is provided with a clip slot 1104 corresponding to the snap clip 1503, and the connection plate 1500 and the upper housing 1100 are detachably attached by the snap clip 1503. This structure enables the user to use the product in a more convenient and labor-saving manner for assembly, so that the user has a better experience of use. In other embodiments (not shown in the drawings), the connection of the connection plate 1500 and the upper housing 1100 is not limited to the snap clip 1503 connection, but may also be a threaded connection and other arbitrary connection methods as desired.

In other embodiments (not shown in the figures), the connection disk 1500 is provided with at least one pin hole N, the lower housing 1200 is provided with at least one pin hole 0 corresponding to the pin hole N. By inserting a pin into the pin holes N, O, the connection disk 1500 and the lower housing 1200 form a fixed connection by means of the pin. In some embodiments, the connection method is not limited to the pin connection and the screw connection, and the connection method in these embodiments may include welding, riveting, gluing, bayonet connection, pin connection, snap ring connection, elastic ring connection, locking connection, mortise and tenon connection, and the like.

As shown in FIGS. 3 to 6, in this embodiment, the connection plate 1500 is provided with at least one threaded hole A 1504, and threaded hole A 1504 is provided with nail slot 1505 that can be embedded with a screw, lower housing 1200 is provided with screwdriver boss 1206, and another end face of the connection plate 1500 is provided with boss groove 1509 that can be embedded with screwdriver boss 1206. Wherein the screwdriver boss 1206 is provided with threaded hole B 1204 corresponding to threaded hole A 1504, and connection plate 1500 is fixedly connected to lower housing 1200 by a screw. In other embodiments (not shown in the figures), the connection between connection plate 1500 and lower housing 1200 is not limited to a threaded connection, but can also be a pinned connection and any other desired connection.

In other embodiments (not shown in the figures), the upper housing 1100 is provided with at least one pin hole M, the connecting disk 1500 is provided with at least one pin hole N corresponding to the pin hole M, and the lower housing 1200 is provided with at least one pin hole 0 corresponding to the pin hole N. The pins are inserted into the pin holes M, N, and O), and the upper housing 1100 and the connecting disk 1500 and the lower housing 1200 form a fixed connection through the pins to form a fixed connection. In some embodiments, the connection method is not limited to the pin connection and the screw connection, and the connection method in these embodiments may include welding, riveting, gluing, bayonet connection, pin connection, snap ring connection, elastic ring connection, locking connection, mortise and tenon connection, and the like.

As shown in FIGS. 3 to 6, in this embodiment, the upper housing 1100 is provided with at least one nail sleeve 1700, the nail sleeve 1700 is provided with a nail sleeve inner groove 1704, and the nail sleeve inner groove 1704 is provided with a chamfer. The chamfer can facilitate screwing in and out, making assembly easier and less tedious for the user. The nail sleeve 1700 comprises a nail sleeve head 1702 and a nail sleeve basel 703, wherein the outer ring of the nail sleeve head 1702 is larger than the outer ring of the nail sleeve base 1703. The upper housing 1100 is provided with at least one nail cover slot 1105 that can be embedded in the nail sleeve head 1702 and is provided with at least one nail sleeve through hole C 1106 that can be passed through the nail sleeve base 1703 that is provided with a through hole D 1701. The connection plate 1500 is provided with at least one base slot 1507 which can be embedded in nail sleeve base 1703 and nail cover slot 1105, and the base slot 1507 is provided with at least one through hole E 1508 corresponding to through hole D 1701, and the connection plate 1500 is provided with at least one boss groove 1509 on the other end face. The lower housing 1200 protrudes with at least one screwdriver boss 1206 which can be embedded in the boss groove 1509, and screwdriver boss 1206 is provided with at least one threaded hole F 1205 corresponding to the through hole E 1508, and the upper housing 1100 is fixedly connected via nail sleeve 1700 to the connection plate 1500 and the lower housing 1200 with screws to achieve a fixed connection. In other embodiments, the connection of upper housing 1100, connection plate 1500 and lower housing 1200 is not limited to the screw connection, but may also be a pin connection and any other connection that meets the requirements.

When using the present apparatus to move a heavy load, a plurality of heavy duty furniture movers are required, and the plurality of heavy duty furniture movers are placed at the lower end of the heavy load to be moved to form a support for the heavy load to lift the heavy load from the ground. Arranging the heavy duty furniture movers under the heavy load with uniform force, placing the heavy load on the heavy duty furniture movers, pushing the heavy load to cause the heavy load to be moved using the heavy duty furniture mover to finally reach a predetermined location to move the heavy load away from the heavy duty furniture mover.

The method of placing a plurality of said heavy loads moving device at the lower end of said heavy loads may include, but is not limited to, lifting said heavy loads using a crane, but may also include lifting using a jack, lifting by a plurality of people working together, and any other method of lifting that is desired. The method of pushing the heavy object may be, but is not limited to, a porter pushing the heavy object, but may also be by pulling by means of a rope, and any other method in accordance with the will to cause the heavy object to be moved using the heavy object moving device to finally arrive at a predetermined location. The manner of removing the heavy object from the heavy object moving device may be, but is not limited to, lifting the heavy object by using a crane, and may also be by using a jack, a plurality of people cooperating in lifting, and any other manner consistent with the will. By retracting the heavy object moving device below the heavy object, the crane lowers the heavy object and places the heavy object on the level on which it is to be placed.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having.” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

What is claimed is:

1. A heavy duty furniture mover comprising:
a clamshell;
wherein the clamshell comprises an upper housing and a lower housing, and a moving device and an elastic device are provided therebetween;
the clamshell is equipped with a connection plate, which is detachably attached to the upper housing and connected with the lower housing, having at least one elastomer on one end face and a moving device on the other end face;
wherein the moving device comprises at least one universal wheel and at least one fixed cover provided on the connection plate, the lower housing is provided with at least one exposed hole, and the fixed cover cooperates with the lower housing in a rollable fixed connection of the universal wheel. Whereby, some small balls are provided between the fixed cover and the universal wheel.

2. A heavy duty furniture mover according to claim 1, wherein said upper housing has attached to it at least one anti-slip mat.

3. A heavy duty furniture mover according to claim 2, wherein said upper housing is provided in the shape of an animal claw.

4. A heavy duty furniture mover according to claim 3, wherein said upper housing can be adjusted to any shape.

5. A heavy duty furniture mover according to claim 4, wherein said upper housing is provided with a hook hole.

6. A heavy duty furniture mover according to claim 5, wherein said upper housing is provided with at least one fixing strip securing elastomer and said connection plate is provided with at least one receiver housing said elastomer and fixing strip.

7. A heavy duty furniture mover according to claim 6, wherein said connection plate is provided with at least one cap slot which is embeddable in said fixed cover.

8. A heavy duty furniture mover according to claim 7, wherein said fixed cover is attached to a snap ring, said snap ring restricting movement of said universal wheel and restricting said small ball between said fixed cover and said universal wheel.

9. A heavy duty furniture mover according to claim 8, wherein said inner wall of said lower housing setting of exposed hole is provided as a curved surface corresponding to said universal wheel.

10. A heavy duty furniture mover according to claim 9, wherein said lower housing is provided with at least one ring tab extending said exposed hole.

11. A heavy duty furniture mover according to claim 10, wherein said upper housing is provided with at least one nail hole and said anti-slip mat protrudes with at least one nail, said anti-slip mat forming a fixed connection to said upper housing by pinning.

12. A heavy duty furniture mover according to claim 11, wherein said connection plate has a snap clip projecting from a side wall, said upper housing is provided with a clip slot corresponding to said snap clip, and said connection plate is detachably attached to said upper housing by means of a snap.

13. A heavy duty furniture mover according to claim 12, wherein said connection plate is provided with at least one threaded hole A and said threaded hole A is provided with a nail slot into which a screw can be embedded, said lower housing is protruding with a screwdriver boss, and said connection plate is provided with a boss groove at the other end face into which said screwdriver boss can be embedded, said screwdriver boss is provided with a threaded hole B corresponding to said threaded hole A, and said connection plate forms a fixed connection with said lower housing by means of a screw.

14. A heavy duty furniture mover according to claim 13, wherein said upper housing is provided with a nail sleeve, said nail sleeve is provided with a nail sleeve inner groove, said nail sleeve comprising a nail sleeve head and a nail sleeve base, said nail sleeve head having an outer ring larger than the outer ring of said nail sleeve base, said upper housing being provided with a nail cover slot embeddable in said nail sleeve head and provided with a through hole C passing through said nail sleeve base, said nail sleeve base being provided with a through hole D, said connection plate set with a base slot embeddable in said nail sleeve base and said nail cover slot, said base slot set with a through hole E corresponding to said through hole D, said connection plate set with a boss groove on the other end face, said lower housing projecting with a screwdriver boss embeddable in said boss groove, said screwdriver boss set with a threaded hole F corresponding to said through hole E, said upper housing passing through said nail sleeve and screwing with said connection plate and said lower housing to effect a fixed connection.

15. A method of moving a heavy object, comprising:
providing a plurality of heavy object moving means:
said heavy object moving means comprising a support assembly, an elastic member provided below said support assembly, a moving assembly provided below said elastic member, said moving assembly comprising at least one gimbal wheel with a plurality of balls provided on said gimbal wheel: placing a plurality of said heavy object moving means at a lower end of said heavy object and forming a support for said heavy object to lift said heavy object from the ground;
wherein placing a plurality of said heavy weight moving means at a lower end of said heavy weight and forming a support for said heavy weight to lift said heavy weight from the ground;
and pushing the heavy object so that the heavy object is moved using the heavy object moving means to finally reach a predetermined location;
removing the heavy object from the heavy object moving assembly.

16. A method of moving a heavy object according to claim 15, wherein a plurality of said heavy object moving assemblies are placed at the lower end of said heavy object, said heavy object is lifted using a crane, said heavy object moving devices are arranged under said heavy object under a uniform force, and said heavy object is placed on said heavy object moving devices.

17. A method of moving a heavy object according to claim 16, wherein the handler pushes said heavy object so that said heavy object is moved using said heavy object moving device to eventually reach a predetermined location.

18. A method of moving a heavy object according to claim 17, wherein a crane is used to lift said heavy object, evacuate said heavy object moving means below said heavy object, and the crane lowers said heavy object, placing said heavy object on the plane on which it is to be placed.
